(19) United States
(12) Patent Application Publication
(10) Pub. No.: US 2008/0100235 A1
(43) Pub. Date: May 1, 2008

(54) FIELD EMISSION BACKLIGHT UNIT AND SCANNING DRIVING METHOD

(75) Inventors: Biing-Nan Lin, Taichung City (TW); Chuan-Hsu Fu, Miaoli County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/678,886

(22) Filed: Feb. 26, 2007

(30) Foreign Application Priority Data
Oct. 26, 2006 (TW) 95139514

(51) Int. Cl. H05B 37/02

(52) U.S. Cl. 315/349

(57) ABSTRACT

A field emission backlight unit comprises a substrate, first electrodes and second electrodes, a fluorescent lighting panel and an anode plate. The first electrodes are disposed on the substrate. The second electrodes are interlaced with the first electrodes and disposed on the substrate. The second electrodes receive a clock signal sequentially according to a first period. The fluorescent lighting panel is disposed at the opposite side of the substrate. The anode plate is disposed at the opposite side of the substrate. When there is a specific voltage between the first electrodes and the second electrodes to generate electrons, the anode plate pulls electrons to hit the fluorescent lighting panel to emit light.

### BACKGROUND OF THE INVENTION

1. Field of the Invention

The invention relates to a field emission backlight unit, and more particularly to a field emission backlight unit with a scanning driving method.

2. Description of the Related Art

FIG. 1 is a schematic diagram of conventional field emission backlight device 100. Field emission backlight device 100 comprises anode plate 140, gate G, cathode electrode Ca, carbon nanotubes CNT, fluorescent lighting plate 110 and substrate 150. There are two driving methods for conventional field emission backlight devices 100, a direct current (DC) driving method and an alternating current (AC) driving method. Anode plate 140 typically varies between 5000V and 10000V, and a DC voltage or an AC voltage is applied between gate G and cathode electrode Ca to generate electrons e′ by point discharge of carbon nanotubes CNT. Electrons e′ are pulled by anode plate 140 and gate G and hit fluorescent lighting plate 110 causing fluorescent lighting plate 110 to emit light.

FIG. 2 shows a cross section of conventional field emission backlight device 100 with cathode electrode Ca and gate G. As shown in FIG. 2, gate G and cathode electrode Ca are interlaced and disposed on substrate 150. In one example, cathode electrode Ca is connected to ground, and a DC voltage or an AC voltage is applied to gate G. Thus, there is a voltage drop between gate G and cathode electrode Ca to generate electrons e′. Electrons e′ are pulled by anode plate 140 and gate G and hit fluorescent lighting plate 110 causing fluorescent lighting plate 110 to emit light.

### BRIEF SUMMARY OF THE INVENTION

A detailed description is given in the following embodiments with reference to the accompanying drawings.

A field emission backlight unit comprises a substrate, first electrodes of a first voltage level disposed on the substrate, second electrodes interlaced with the first electrodes on the substrate, a pulse signal inputted to the second electrodes sequentially according to a first period, a fluorescent lighting panel disposed at an opposite side of the substrate and an anode plate disposed at the opposite side of the substrate. If there is a specific voltage between the first electrodes and the second electrodes for generating a plurality of electrons, the electrons hitting the fluorescent lighting panel cause the anode to emit light.

A scanning driving method for driving a field emission backlight unit is provided. The field emission backlight unit comprises a fluorescent lighting panel, an anode plate, a substrate, first electrodes and second electrodes. The first electrodes and the second electrodes are interlaced and disposed on the substrate. The fluorescent lighting panel and the anode plate are disposed at an opposite side of the substrate. The scanning driving method comprises applying a first voltage level on the first electrodes, and applying a pulse signal on the second electrodes sequentially according to a first period. If there is a specific voltage between the first electrodes and the second electrodes for generating a plurality of electrons, electrons hitting the anode cause the fluorescent lighting panel to emit light.

A field emission backlight unit comprises a substrate, first electrodes, a fluorescent lighting panel and an anode. The first electrodes is disposed on the substrate and have a first voltage level The second electrode groups each comprises at least two second electrodes interlaced with the first electrodes on the substrate. A pulse signal is input to the second electrodes sequentially according to a first period. The fluorescent lighting panel is disposed at an opposite side of the substrate. The anode plate is disposed at the opposite side of the substrate. If there is a specific voltage between the first electrodes and the second electrodes for generating a plurality of electrons, electrons hitting the anode cause the fluorescent lighting panel to emit light.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional field emission backlight device;

FIG. 2 shows a cross section of a conventional field emission backlight device;

FIG. 3A is a schematic diagram of a field emission backlight device according to an embodiment of the invention;

FIG. 3B is a schematic diagram of a field emission backlight device according to another embodiment of the invention;

FIG. 4A shows a cross section of a field emission backlight device according to an embodiment of the invention;

FIG. 4B shows a cross section of a field emission backlight device according to another embodiment of the invention;

FIG. 5A is a timing diagram of a field emission backlight device according to another embodiment of the invention;

FIG. 5B is a timing diagram of field emission backlight device according to another embodiment of the invention; and

FIG. 6 is a schematic diagram of a field emission backlight device according to another embodiment of the invention.

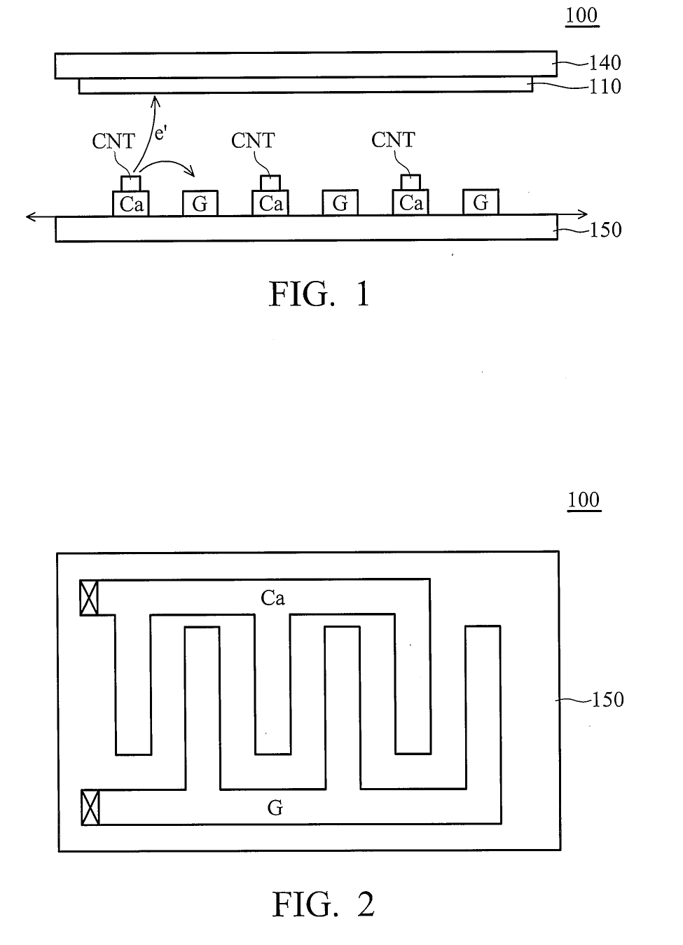

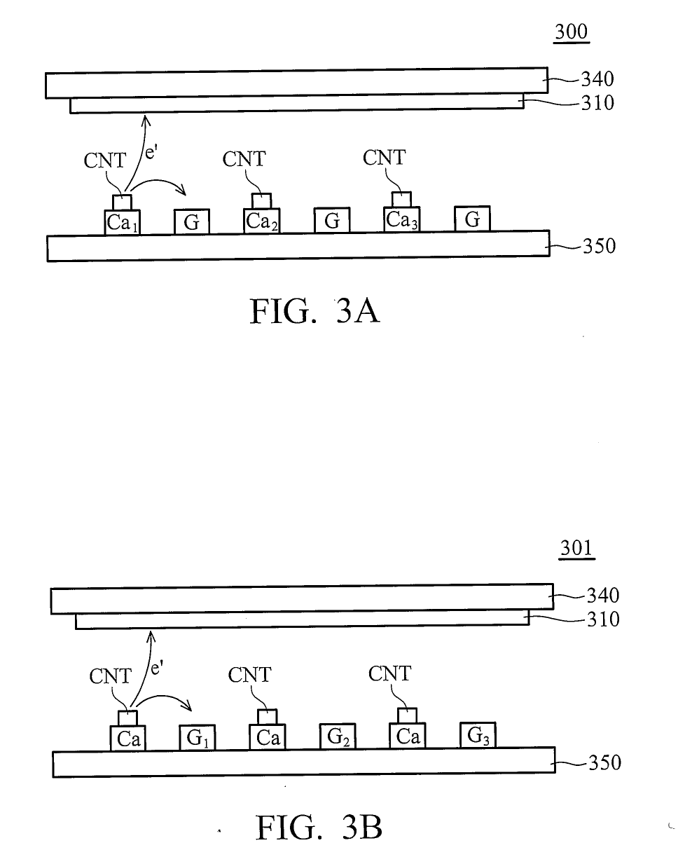

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

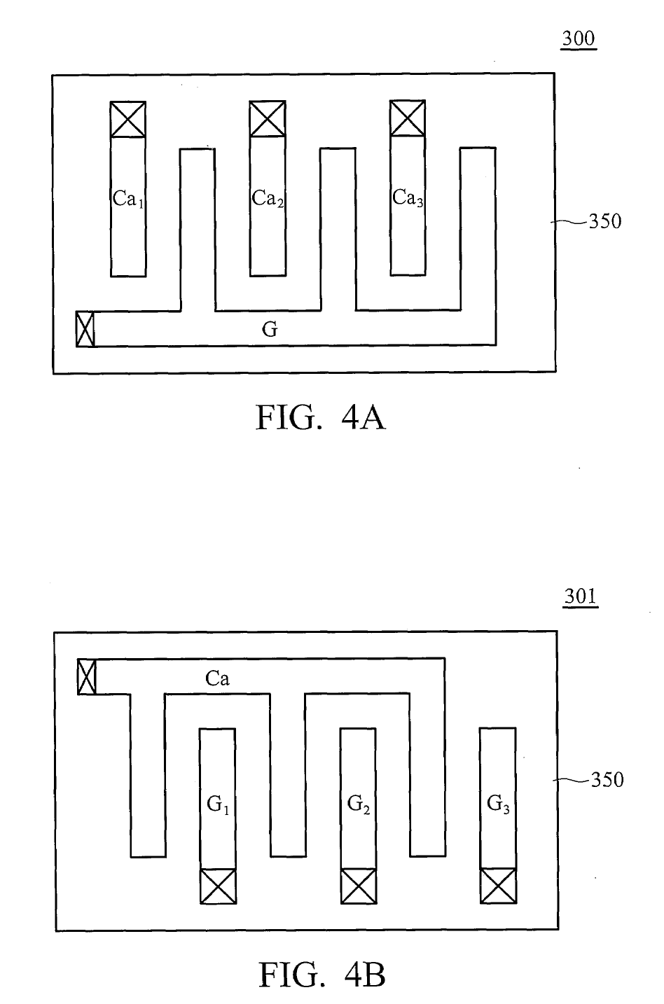

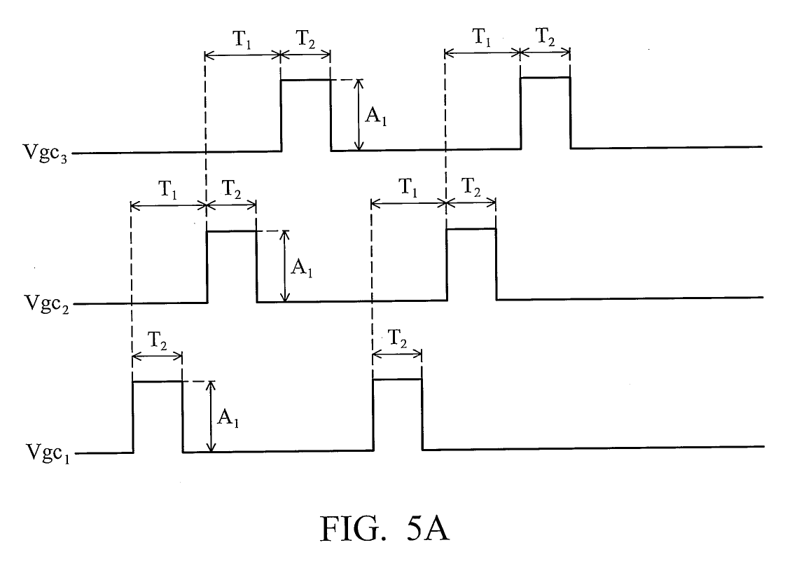

FIG. 3A is a schematic diagram of field emission backlight device 300 according to an embodiment of the invention. FIG. 4A shows a cross section of field emission backlight device 300 with cathode electrodes Ca₁, Ca₂ and Ca₃ and gate G according to an embodiment of the invention. As shown in FIGS. 3A and 4A, field emission backlight device 300 comprises anode plate 340, gate G, cathode electrodes Ca₁, Ca₂ and Ca₃, carbon nanotubes CNT, fluorescent lighting plate 310 and substrate 350. As known in FIG. 4A, gate G and cathode electrodes Ca₁, Ca₂ and Ca₃ are interlaced and disposed on substrate 350. If the voltage drop between gate G and cathode electrodes Ca₁, Ca₂ and Ca₃, is adequate, such as 300V, carbon nanotubes CNT are discharged from points thereof to generate electrons e′. Electrons e′ are pulled by anode plate 340 and gate G and hit fluorescent lighting plate 310 causing fluorescent lighting plate 310 to emit light. Anode plate 340 can be an ITO (Indium Tin Oxide) layer coated on a glass substrate or composed of a substrate and an anode electrode layer. The anode electrode layer can be formed by screen printing, spin coating, evaporation deposition, sputtering and similar. For brevity, FIGS. 3A and 4A only show three gates G interlaced with three cathode electrodes Ca₁, Ca₂ and Ca₃ disposed on substrate 350 to represent that field emission backlight device 300 comprises a plurality of gates and a plurality of cathode electrode. Because each cathode of the field emission backlight device of the invention is driven by an independent driving element and each driving element consumes less power, the field emission backlight device of the invention can be used to light a larger area.

FIG. 3B is a schematic diagram of field emission backlight device 301 according to another embodiment of the invention. FIG. 4B shows a cross section of field emission backlight device 301 with cathode electrodes Ca and gates G₁, G₂ and G₃ according to another embodiment of the invention. As shown in FIGS. 3B and 4B, field emission backlight device 301 comprises anode plate 340, gates G₁, G₂ and G₃, cathode electrode Ca, carbon nanotubes CNT, fluorescent lighting plate 310 and substrate 350. As known in FIG. 4B, gates G₁, G₂ and G₃ and cathode electrode Ca are interlaced and disposed on substrate 350. If the voltage drop between gates G₁, G₂ and G₃ and cathode electrode Ca, is adequate, such as 300V, carbon nanotubes CNT are discharged from points thereof to generate electrons e′. Electrons e′ are pulled by anode plate 340 and gate G₁, G₂ and G₃ and hit fluorescent lighting plate 310 causing fluorescent lighting plate 310 to emit light.

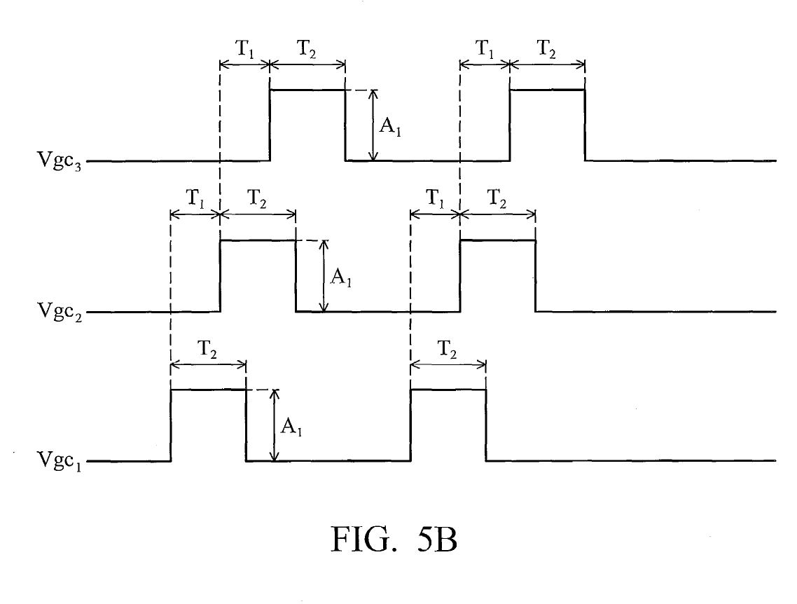

FIG. 5A is a timing diagram of field emission backlight device 300 according to another embodiment of the invention. Amplitude A₁, frequency or pulse widths T₂ of each signal Vgc₁, Vgc₂ and Vgc₃ are all the same and only the phases thereof are different. In one of embodiments, signal Vgc₂ is generated by delaying signal Vgc₁ by period T₁ and signal Vgc₃ is generated by delaying signal Vgc₂ by period T₁. Using FIGS. 4A and 4B as examples, signal Vgc₁ is a voltage between gate G and cathode Ca₁, signal Vgc₂ is a voltage between gate G and cathode Ca₂, and signal Vgc₃ is a voltage between gate G and cathode Ca₃.

According to an embodiment of the invention, using FIG. 4A as an example, gate G receives 300V voltage and cathode electrodes Ca₁, Ca₂ and Ca₃ receive a pulse signal with a specific frequency. The pulse signal has two voltage levels, 0V and 100V. The specific frequency is between 100 Hz and 50 KHz. According to the above conditions, amplitude A1 of signals Vgc₁, Vgc₂ and Vgc₃ in FIG. 5A is 100V. If the high voltage level of signal Vgc₁ is 300V, there is a 300V voltage drop between gate G and cathode Ca1, generating electrons e′. Electrons e′ are pulled by anode plate 340 and gate G, and hit fluorescent lighting plate 310 to cause fluorescent lighting plate 310 to emit light. If the low voltage level of signal Vgc₁ is 200V, there is a 200V voltage drop between gate G and cathode Ca1 to generate few electrons e′. Similarly, if the voltage levels of signals Vgc₂ and Vgc₃ are 300V, electrons e′ cause the fluorescent lighting plate 310 to emit light. In another embodiment, using FIG. 4B as an example, cathode Ca is connected to ground, and gates G₁, G₂ and G₃ receive a pulse signal with a specific frequency. The pulse signal has two voltage levels, 300V and 200V. The specific frequency is between 100 Hz and 50 KHz. The operation is similar to the previously described operation, thus, it is not described again here.

Because the fluorescent powders of fluorescent lighting plate 310 have a characteristic decay time, the brightness of fluorescent lighting plate 310 decreases over time. Fluorescent lighting plate 310 must wait for the next period to receive electrons e′ before emitting light again. In addition, using FIGS. 3A and 4A as an example, because the voltage of signals Vgc₁, Vgc₂ and Vgc₃ become 300v sequentially, and gate G and cathodes Ca₁, Ca₂ and Ca₃ are interlaced and disposed on substrate 350, cathodes Ca₁, Ca₂ and Ca₃ sequentially generate electrons e′ for each part of fluorescent lighting plate 310 to emit light by turns. Thus, field emission backlight device 300 can uniformly emit light. In another embodiment, period T₁ of signals Vgc₁, Vgc₂ and Vgc₃ is shorter than period T₂ of the pulse signals, as shown in FIG. 5B. Thus, cathodes Ca₁, Ca₂ and Ca₃ generate electrons e′ sequentially, and the periods of generating electrons of cathodes Ca₁, Ca₂ and Ca₃ overlap each other for improving the brightness of light emitted by field emission backlight device 300. In another embodiment, field emission backlight device 300 can be applied in the backlight of a liquid crystal display to improve the known motion blur problem.

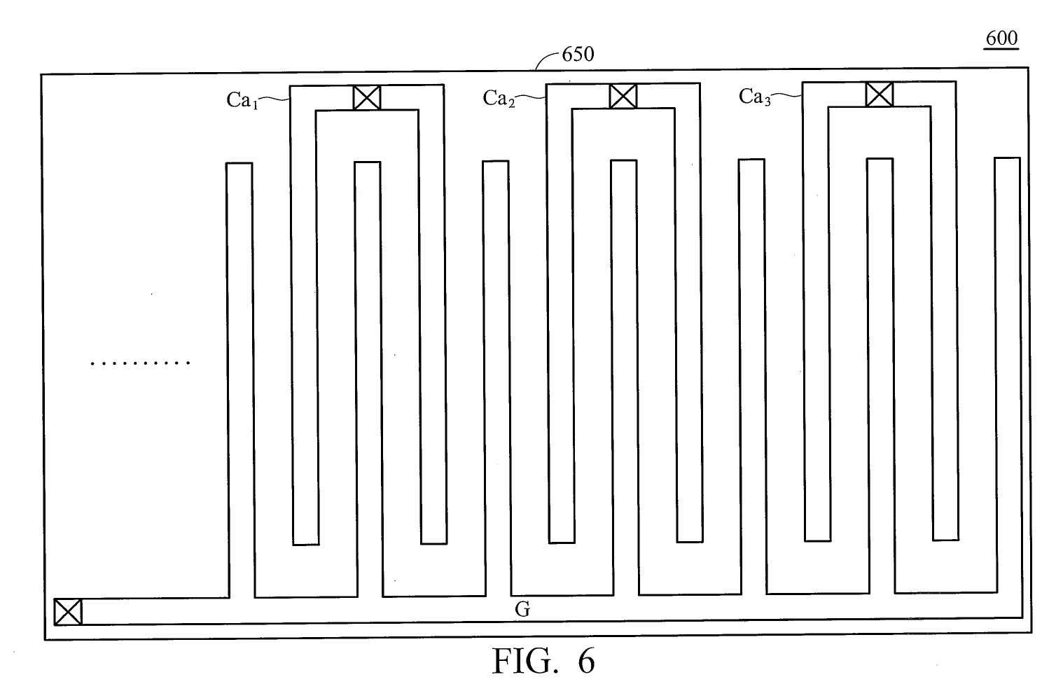

FIG. 6 is a schematic diagram of field emission backlight device 600 according to another embodiment of the invention. Field emission backlight device 600 comprises a plurality of cathode groups (such as Ca₁, Ca₂ and Ca₃), and each cathode group comprises at least two independent cathodes. According to an embodiment of the invention, gate G receives 300V voltage, and cathode groups Ca₁, Ca₂ and Ca₃ receive pulse signals with a specific frequency, such as signal Vgc₁, Vgc₂ and Vgc₃ in FIG. 5. The anode plate, fluorescent light panel, carbon nanotubes and lighting method in FIG. 6 are the same as those in FIGS. 3A, 3B, 4A and 4B, thus, they are not described in detail here. Because electrodes of field emission backlight device 600 are separated into a plurality of groups, field emission backlight device 600 can use a single driver more efficiently and use fewer driving elements in a single driver to reduce costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A field emission backlight unit, comprising:
a substrate;
first electrodes disposed on the substrate and having a first voltage level;
second electrodes interlaced with the first electrodes on the substrate, wherein a pulse signal is input into the second electrodes sequentially according to a first period;
a fluorescent lighting panel disposed at an opposite side of the substrate; and
an anode plate disposed at the opposite side of the substrate, wherein if there is a specific voltage between the first electrodes and the second electrodes for generating a plurality of electrons, the electrons hitting the fluorescent lighting panel cause the anode to emit light.

2. The field emission backlight unit as claimed in claim 1, wherein the first electrodes are coupled to each other.

3. The field emission backlight unit as claimed in claim 1, wherein the second electrodes are coupled to each other.

4. The field emission backlight unit as claimed in claim 1, further comprising at least one emission source disposed on the second electrodes.

5. The field emission backlight unit as claimed in claim 4, wherein the emission sources are carbon nanotubes.

6. The field emission backlight unit as claimed in claim 1, wherein the pulse signal varies between a second voltage level and a third voltage level with a first frequency.

7. The field emission backlight unit as claimed in claim 6, wherein the first voltage level is 300V, the second voltage level is 0V, the third voltage level is 100V and the first frequency is between 100 Hz and 50 KHz.

8. The field emission backlight unit as claimed in claim 1, wherein the anode further comprises a first substrate and an electrode layer.

9. The field emission backlight unit as claimed in claim 1, wherein the pulse signal is input into at least two second electrodes sequentially according to the first period.

10. A scanning driving method for driving a field emission backlight unit, the field emission backlight unit comprising a fluorescent lighting panel, an anode plate, a substrate, first electrodes and second electrodes, the first electrodes and the second electrodes interlaced with each other and disposed on the substrate, the fluorescent lighting panel and the anode plate disposed at an opposite side of the substrate, comprising:
applying a first voltage level on the first electrodes; and
applying a pulse signal on the second electrodes sequentially according to a first period, wherein if there is a specific voltage between the first electrodes and the second electrodes for generating a plurality of electrons, the electrons hitting the fluorescent lighting panel cause the anode to emit light.

11. The scanning driving method as claimed in claim 10, wherein the first electrodes are coupled to each other.

12. The scanning driving method as claimed in claim 10, wherein the second electrodes are coupled to each other.

13. The scanning driving method as claimed in claim 10, further comprising at least one emission source disposed on the second electrodes.

14. The scanning driving method as claimed in claim 13, wherein the emission sources are carbon nanotubes.

15. The scanning driving method as claimed in claim 10, wherein the pulse signal varies between a second voltage level and a third voltage level with a first frequency.

16. The scanning driving method as claimed in claim 15, wherein the first voltage level is 300V, the second voltage level is 0V, the third voltage level is 100V and the first frequency is between 100 Hz and 50 KHz.

17. The scanning driving method unit as claimed in claim 10, wherein the anode further comprises a first substrate and an electrode layer.

18. The scanning driving method as claimed in claim 10, wherein the pulse signal is input into at lease two second electrodes sequentially according to the first period.

19. A field emission backlight unit, comprising:
a substrate;
first electrodes disposed on the substrate and having a first voltage level;
second electrode groups, each second electrode group comprising at least two second electrodes, the second electrodes interlaced with the first electrodes on the substrate, a pulse signal input into the second electrodes sequentially according to a first period;
a fluorescent lighting panel disposed at an opposite side of the substrate; and
an anode plate disposed at the opposite side of the substrate, wherein if there is a specific voltage between the first electrodes and the second electrodes for generating a plurality of electrons, the electrons hitting the fluorescent lighting panel cause the anode to emit light.

20. The field emission backlight unit as claimed in claim 19, wherein the first electrodes are coupled to each other.

21. The field emission backlight unit as claimed in claim 19, wherein the second electrodes are coupled to each other.

22. The field emission backlight unit as claimed in claim 19, further comprising at least one emission source disposed on the second electrode group.

23. The field emission backlight unit as claimed in claim 19, wherein the pulse signal varies 0V or 100v with a first frequency, the first frequency is between 100 Hz and 50 KHz and the first voltage level is 300V.
